(19) United States
(12) Patent Application Publication
(10) Pub. No.: US 2015/0035984 A1
(43) Pub. Date: Feb. 5, 2015

(54) In-Vehicle Image Processing Device and Method

(71) Applicant: Hitachi Automotive Systems, Ltd., Hitachinaka-shi, Ibaraki (JP)

(72) Inventor: Yuji Otsuka, Hitachinaka (JP)

(21) Appl. No.: 14/379,660

(22) PCT Filed: Feb. 6, 2013
(86) PCT No.: PCT/JP2013/052651

§ 371 Date: Aug. 19, 2014

(30) Foreign Application Priority Data
Mar. 23, 2012 (JP) 2012-067158

(51) Int. Cl. H04N 7/18; H04N 5/335; B60R 1/00; H04N 5/235

(52) U.S. Cl. CPC H04N 7/181; H04N 5/2353; H04N 5/335; B60R 1/00; B60R 2300/30; B60R 2300/8093
USPC 348/148

(57) ABSTRACT

The object of the present invention is to improve the detection capability for detecting a preceding vehicle that may collide with a driver's vehicle using a stereo camera having rolling shutter types of CMOS sensor. The present invention relates to an in-vehicle image processing device that includes: plural imaging sections for imaging the area ahead of a driver's vehicle; an image processing section for detecting another vehicle using disparity information about plural images obtained by the imaging sections. In this case, the imaging sections include imaging devices the exposure timing of each of which is different on the basis of a line of the imaging screen, and the imaging devices are sequentially exposed in the direction from the lowermost edge to the uppermost edge of the another vehicle.

### TECHNICAL FIELD

The present invention relates to an in-vehicle image processing device and method that are used for obtaining images around a vehicle and detecting obstacles and the like.

### BACKGROUND ART

In-vehicle processing for detecting an obstacle in front of a vehicle using an in-vehicle camera has been widely researched and developed as a precautionary safety technology for vehicle. In particular, since a stereo camera, which is disclosed in Patent Literature 1 and uses two cameras, can detect a distance to an obstacle, the stereo camera can be used for building a higher-performance system in comparison with a typical monocular camera, so that a various kinds of application can be materialized.

Since a stereo camera uses two cameras, it becomes important to select a type of imaging device when it is taken into consideration for the stereo camera to be made as a commercial product. A CMOS sensor has an advantage in that it needs a smaller number of components and consumes less electric power than a CCD. Therefore, it has been widely used in recent years, and there are many types of low-cost CMOS sensor. Generally speaking, however, the exposure scheme of a CCD and that of a CMOS sensor are greatly different from each other in reality.

In a CCD, since a scheme in which all pixels are exposed and the contents of all the pixels are read out simultaneously, that is, a so-called global shutter scheme, is employed, the entirety of one screen can be exposed. On the other hand, in a CMOS sensor, a scheme in which each line of one screen is exposed and the contents of the line are read out simultaneously on a line-by-line basis, that is, a so-called rolling shutter scheme is employed, therefore the entirety of one screen can not be exposed at the same time. Generally, pixels are sequentially exposed from the pixels of the uppermost line of the screen to the pixels of the lowermost line. Therefore, in the rolling shutter scheme, if the positional relation between a camera and a photographic subject is changing, that is, in the case where either the camera or the photographic subject is moving, a shape distortion occurs owing to deviations among photographing times

Since a fundamental operation condition in in-vehicle applications is a condition in which a driver's vehicle is moving or a preceding vehicle, which is a photographic subject, is moving, this shape distortion problem is unavoidable. This shape distortion also leads to a deviation of disparity in a stereo camera, which incurs the degradation of detection capability and the degradation of distance measuring capability. Therefore, in order to fully utilize the capability of a stereo camel-a, it is desirable that a CCD having a global shutter function or a global shutter type of special CMOS sensor should be employed.

However, in view of the above-mentioned advantage of the low cost and low power consumption of the CMOS sensor, it is needed that the capability of the stereo camera should be fully utilized using a rolling shutter type of CMOS sensor.

### CITATION LIST

### Patent Literature

Patent Literature 1: Japanese Unexamined Patent Application Publication No. Heil(1989)-26913

### SUMMARY OF INVENTION

### Technical Problem

One of the objects of the present invention is to improve the detection capability for detecting a preceding vehicle that may collide with a driver's vehicle and to provide a low-cost detection scheme using rolling shutter types of CMOS sensor having the advantage of low cost and low power consumption.

### Solution to Problem

In order to address the above problem, an in-vehicle image processing device according to the present invention includes: plural imaging sections for imaging the area ahead of a driver's vehicle; an image processing section for detecting another vehicle using disparity information about plural images obtained by the imaging sections. In this case, the imaging sections include imaging devices the exposure timing of each of which is different on the basis of a line of the imaging screen, and the imaging devices are sequentially exposed in the direction from the lowermost edge to the uppermost edge of the another vehicle.

### Advantageous Effects of Invention

According to the present invention, the detection capability for detecting a preceding vehicle that may collide with a driver's vehicle can be improved and a low-cost detection scheme can be provided using rolling shutter types of CMOS sensor having the advantage of low cost and low power consumption.

### BRIEF DESCRIPTION OF DRAWINGS

FIG. 1 shows a block diagram of the configuration of an in-vehicle control device for materializing FCW (forward collision control) and/or ACC (adaptive cruise control) according to an embodiment of the present invention.

FIG. 2 shows a configuration diagram of a camera and an image analysis unit according to this embodiment.

FIG. 3 shows a diagram for explaining a color reproduction scheme using color devices.

FIG. 4 shows a diagram for explaining distance measuring using a stereo camera.

FIG. 5 shows an image obtained by imaging a preceding vehicle in front of a driver's vehicle.

FIG. 6 is an image diagram showing how the preceding vehicle is imaged by a rolling shutter scheme according to an example of the related art when the preceding vehicle is coming near.

FIG. 7 is an image diagram showing how the preceding vehicle is imaged by a rolling shutter scheme according to this embodiment when the preceding vehicle is coming near.

FIG. 8 shows the normal shape of the preceding vehicle.

### DESCRIPTION OF EMBODIMENTS

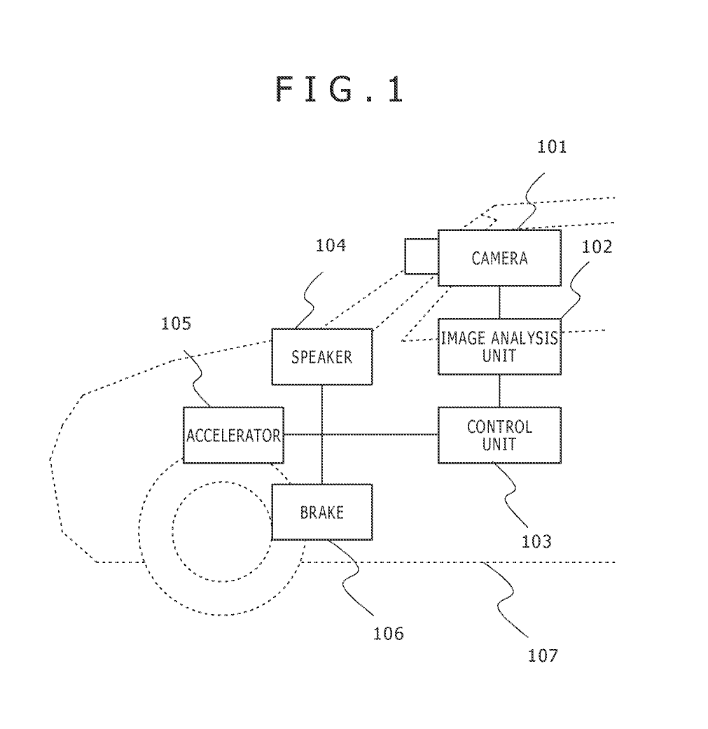

FIG. 1 shows the outline of the entire configuration for materializing FCW (forward collision control) and/or ACC (adaptive cruise control) according to an embodiment of the present invention. A camera 101, which is an imaging section, is mounted on a vehicle 107 in order for the camera to be able to capture the visual range in front of the vehicle 107. Images in front of the vehicle imaged by the camera 101 are input into an image analysis unit 102, which is an image processing section, and the image analysis unit 102 calculates a distance to the preceding vehicle and a relative velocity using the input images in front of the vehicle. Information obtained by the calculation is sent to a control unit 103.

The control unit 103 determines the degree of risk of collision using the distance to the preceding vehicle and the relative velocity, and issues instructions to give an alarm sound from a speaker 104, to decelerate the vehicle 107 by applying a brake 106, and other instructions. In addition, if the driver sets an ACC function operative, the control unit 103 performs control over an accelerator 105 so that the vehicle 107 follows the preceding vehicle with a certain distance therebetween. In the case where there is no preceding vehicle, the control unit 103 performs control over an accelerator 105 so that the vehicle 107 is accelerated no have a configured velocity, and other kinds of control. In addition, if the distance to the preceding vehicle becomes short, the control unit 103 performs control so that the velocity of the vehicle 107 is slowed down by easing up on the accelerator 105 and by applying the brake 106, and performs other kinds of control.

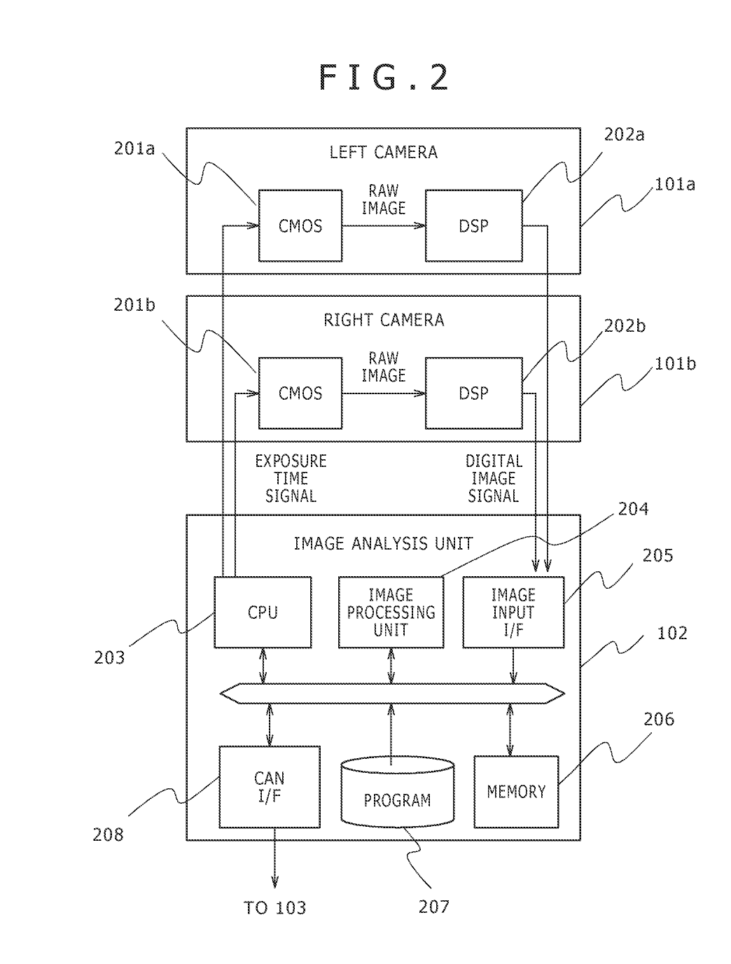

Next, a method in which a preceding vehicle is detected using a camera will be described. FIG. 2 shows internal configurations of the camera 101 (including a pair of a left camera 101a and a right camera 101b) and the image analysis unit 102 shown in FIG 1. CMOSs (complementary metal semiconductors) 201, which are respectively imaging devices for the left camera 101a and the right camera 101b, are imaging devices each of which includes an array of photodiodes that convert light to electric charge. In the case where the CMOSs 201 are color devices, raw images are transferred to DSPs 202, and are converted into grayscale images. The grayscale images are sent to an image input I/F 205 of the image analysis unit 102. In the case where the CMOSs 201 are monochrome elements, raw images are sent as they are to an image input I/F 205 of the image analysis unit 102.

Although image signals are continuously sent, the leading part of each image signal includes a synchronous signal, and only images having needed timings can be loaded by the image input I/F 205. The images loaded by the image input I/F 205 are written into a memory 206, and disparity calculation processing and analysis are executed on the images by an image processing unit 204. These pieces of processing will be described later. This series of processing is performed in accordance with a program 207 that has been written in a flash ROM. A CPU 203 performs control and necessary calculation so that the image input I/F 205 loads images and the image processing unit 204 performs image processing.

The CMOS 201 embeds an exposure control unit for performing exposure control and a register for setting an exposure time therein, and images a photographic subject with the exposure time set by the register. The content of the register can be rewritten by the CPU 203, and the rewritten exposure time is reflected at the time of imaging the next frame or next field and later. The exposure time is electrically controllable, and puts a restraint on the amount of light applied to the CMOS 201. Although the control of exposure time can be performed by such an electric shutter scheme as mentioned above, it can be similarly performed by a scheme in which a mechanical shutter is opened or closed. In addition, it is also conceivable that the exposure amount is changed by adjusting an aperture. In addition, if lines are operated every other line as is the case with interlacing, it is conceivable that the exposure amount for odd lines and the exposure amount for even lines are set to be different from each other.

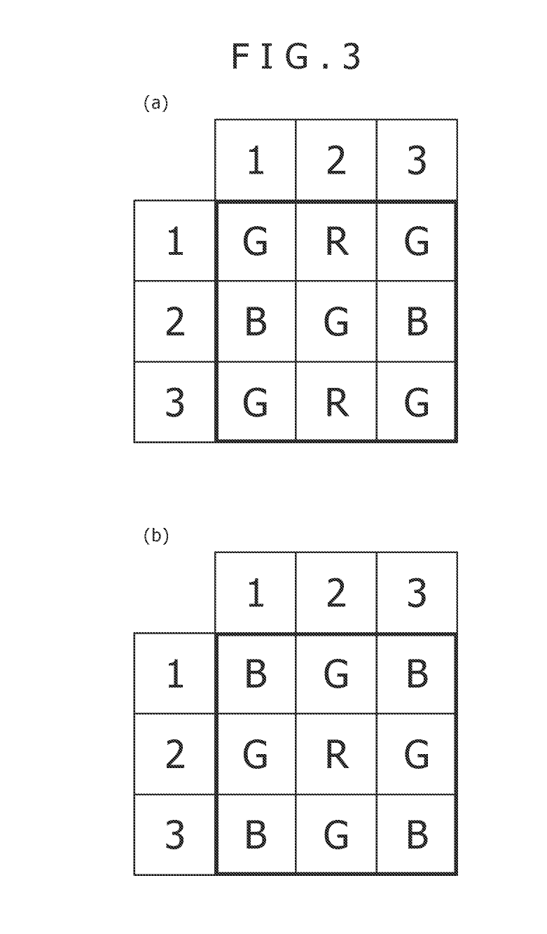

Here, the scheme of converting a raw image into a grayscale image performed by the DSP 202 will be described. In the case of a color device, since each pixel, can measure only the intensity (density) of one color out of red (R) color, green (G) color, and blue (B) color, colors other than the measured color are estimated with reference to colors surrounding the measured color. For example, R, G, and B colors of a pixel in the position G22 at the center of FIG. 3 (a) are obtained from the next expressions (1).

$$\{ \begin{matrix}R = \frac{{R}_{12} + {R}_{32}}{2} \\ G = {G}_{22} \\ B = \frac{{B}_{21} + {B}_{23}}{2}\end{matrix} \qquad ( 1 )$$

Similarly, R, G, and B colors of a pixel in the position R22 at the center of FIG. 3 (b) are obtained from the next expressions (2).

$$\{ \begin{matrix}R = {R}_{22} \\ G = \frac{{G}_{21} + {G}_{12} + {G}_{32} + {G}_{23}}{4} \\ B = \frac{{B}_{11} + {B}_{13} + {B}_{31} + {B}_{33}}{4}\end{matrix} \qquad ( 2 )$$

R colors, G colors, and B colors of other pixels can be obtained in a similar way. As such calculations as above are sequentially continued, three primary colors, that is, R, G, and B colors of every pixel can be calculated, which makes it possible to obtain a color image. Using the calculation results of all pixels, the luminance Y about each pixel can be obtained from the next expressions (3), a Y image is created, and the Y image is set down as a grayscale image.

Y=0.299R+0.587G+0.114B (3)

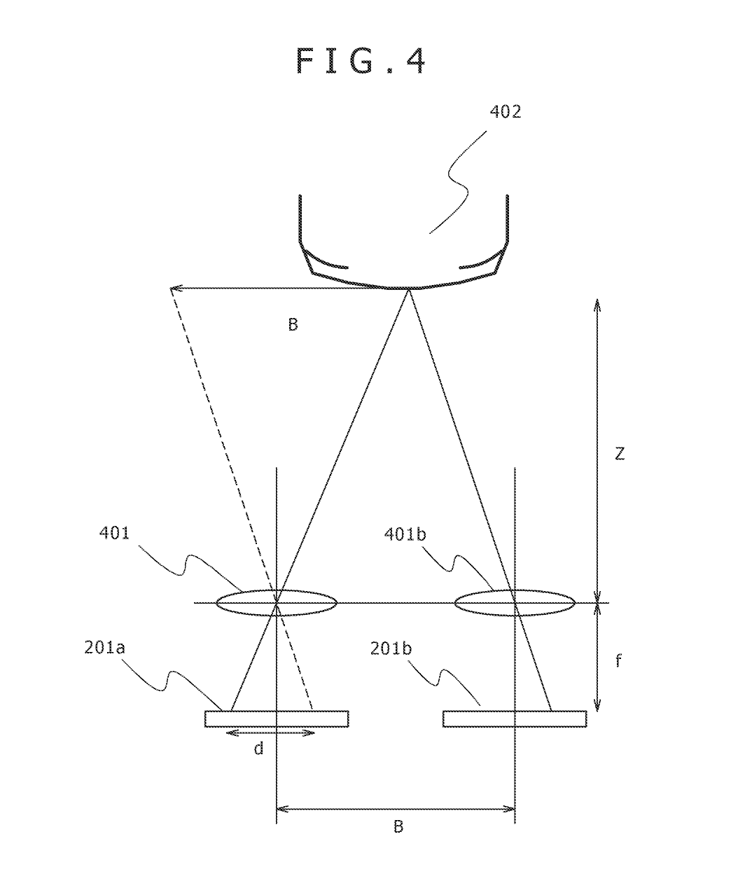

Next, disparity calculation will be explained with reference to FIG. 4. If it will be assumed that a distance from a camera to a preceding vehicle 409 is represented as Z, a base length between a left optical axis and a right optical axis is represented as B, a focal length is represented as f, and a disparity on a CMOS is represented as d, the distance Z can be obtained from the next expression using the homothetic ratio between two triangles

$$Z = \frac{Bf}{d} \qquad ( 4 )$$

As shown in FIG. 4, the distance Z is a distance from the principal point of a lens 401 to be precise.

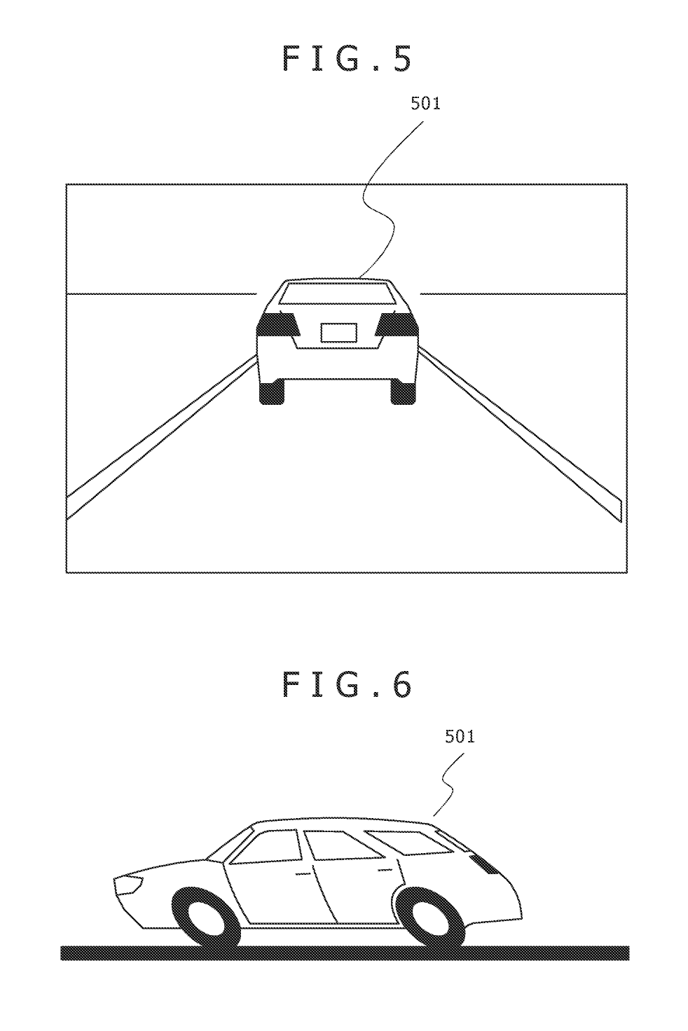

Next, if the imaging devices of the stereo camera are rolling shutters, a problem that occurs in the case where FCW or ACC is materialized will be described with reference to FIG. 5 and FIG. 6. FIG. 5 shows an image obtained by imaging a preceding vehicle 501. In this situation, let's consider the case where the driver's vehicle 107 comes so near to the preceding vehicle 501 as to almost collide with the preceding vehicle 501.

In the case of the imaging devices being rolling shutters, the imaging devices are sequentially exposed from the upper most line on the screen, and the lowermost line of the screen is exposed at the last, and since the preceding vehicle are gradually approaching during this time, the lower part of the preceding vehicle is imaged more closely than the upper part of the preceding vehicle. In other words, distances to the preceding vehicle 501 are measured as if the preceding vehicle 501 were deformed with its upper part bent forward as shown in FIG. 6. In the case where a stereo camera is used for detecting a vehicle, since it leads to the stability of the detection that the disparities of the rear of the vehicle are uniform and not varied, if the image of the preceding vehicle is in the state shown in FIG. 6, the disparity of the upper edge of the vehicle and that of the lower edge are different from each other, and the calculated distances to the upper edge and to the lower edge are also different from each other, which leads to the degradation of the stability of the detection.

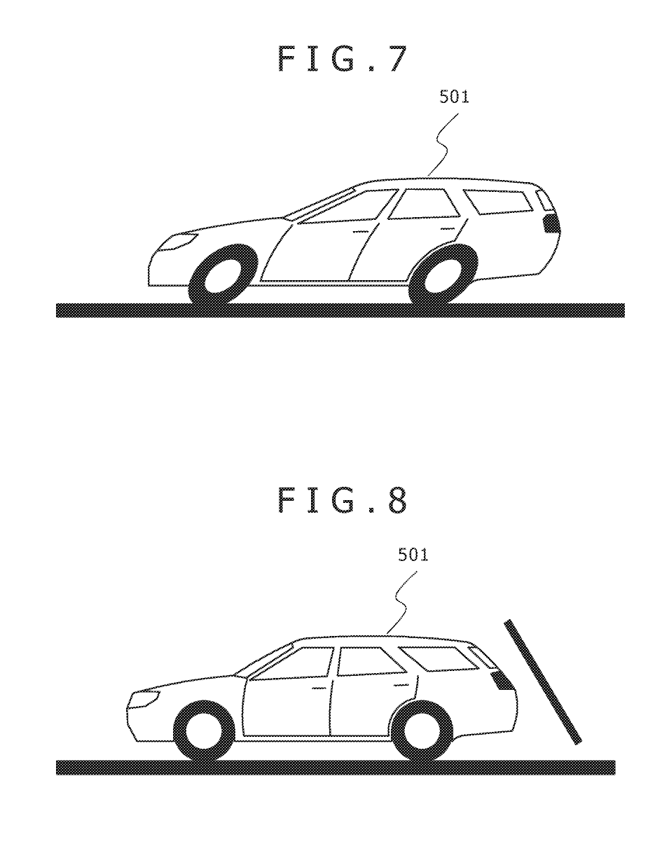

Therefore, the CMOS 201, which is an imaging device, is mounted physically upside down. The image that is upside down is turned back by the image processing unit 204. As a result, since the upper edge of the preceding vehicle is imaged later in terms of time than the lower part of the preceding vehicle, the upper edge of the preceding vehicle is imaged nearer to the driver's vehicle, so that the preceding vehicle is imaged as if it were inversely deformed as shown in FIG. 7 The lower parts of the rears of almost all vehicles are more protruding than the upper parts by their bumpers, so that the upper parts of the vehicles are leaning forward from the vertical. Therefore, since the rear of a vehicle is nearer to the vertical in the case of the vehicle being deformed. as shown in FIG. 7 than in the case of the vehicle being deformed as shown in FIG. 6, the detection can be performed stably.

On the other hand, if the preceding vehicle is leaving from the driver's vehicle, the preceding vehicle is imaged as shown in FIG. 6, which leads to the instability of the detection. However, in either of the case where FCW is employed and the case where ACC is employed, the degree of risk of collision becomes larger when the preceding vehicle is coming near than when the preceding vehicle is leaving, so that it is more important to make the detection performed when the preceding vehicle is coming near stable. Therefore, it is more advantageous to mount the CMOS 201 physically upside down than to mount the CMOS 201 normally.

Although the above embodiment has been described under the assumption that the CMOS 201 is mounted physically upside down, since it is all right if the order of exposure is reversed from the lowermost line to the uppermost line, it is conceivable that a device, which is configured to electronically reverse the order of exposure from the lowermost line to the uppermost line without mounting the CMOS 201 physically upside down, is used

### LIST OF REFERENCE SIGNS

101 . . . Camera, 102 . . . Image Analysis Unit, 103 . . . Control Unit, 104 . . . Speaker, 105 . . . Accelerator, 106 . . . Brake, 107 . . . Driver's Vehicle, 201a, 201b . . . CMOS, 202a, 202b . . . DSP, 203 . . . CPU, 204 . . . Image Processing Unit, 205 . . . Image Input I/F, 206 . . . Memory, 207 . . . Program (on Flash ROM), 208 . . . CAN I/F, 401 . . . Lens, 402 . . . Distance Measuring Target (Preceding Vehicle), 501 . . . Preceding Vehicle

1. An in-vehicle image processing device comprising:
a plurality of imaging sections for imaging the area ahead of a driver's vehicle; and
an image processing section for detecting another vehicle using disparity information about a plurality of images obtained by the imaging sections,
wherein the imaging sections include imaging devices the exposure timing of each of which is different on the basis of a line of the imaging screen, and the imaging devices are sequentially exposed in the direction from the lowermost edge to the uppermost edge of the another vehicle.

2. The in-vehicle image processing device according to claim 1, wherein the imaging devices are CMOS sensors.

3. The in-vehicle image processing device according to claim 2, wherein the CMOS sensors are mounted upside down.

4. The in-vehicle image processing device according to claim 2, wherein the CMOS sensors are mounted in their normal positions, and the order of exposure is electronically reversed in the direction from the lowermost edge to the uppermost edge of the another vehicle.

5. An in-vehicle image processing method comprising:
a first step of obtaining a plurality of images of the area ahead of a driver's vehicle; and
a second step of detecting another vehicle using disparity information about the images obtained at the first step,
wherein, the first step is a step in which the lines of the imaging screens are exposed at exposure timings different from each other in the direction from the lowermost edge to the uppermost edge of the another vehicle.
